(19) United States
(12) Patent Application Publication
(10) Pub. No.: US 2003/0126447 A1
(43) Pub. Date: Jul. 3, 2003

(54) Trusted high stability time source

(76) Inventors: Jacques Debiez, Cugnaux (FR); James P. Hughes, Lino Lakes, MN (US)

Correspondence Address: Wayne P. Bailey, Storage Technology Corporation, One StorageTek Drive, MS-4309, Louisville, CO, 80028-4309, US

(21) Appl. No.: 10/034,952

(22) Filed: Dec. 27, 2001

(51) Int. Cl. H04L 9/00

(52) U.S. Cl. 713/178

(57) ABSTRACT

A trusted high stability time source for use with a digital time stamping service and a trusted external time source includes a private time source, a published time source, at least one power supply, and control logic. The control logic is programmed to perform a time stamping operation and to perform a published time source update. In performing the published time source update, a reply received from the trusted external time source includes the published time update, and the published time is updated with the published time update if an update condition is satisfied. The update condition is based in part on a time difference between the private time and the published time update.

### BACKGROUND OF THE INVENTION

1. Field of the Invention

The present invention relates to trusted time sources suitable for use with digital time stamping services.

2. Background Art

A digital time stamping service is a service that receives a message digest, appends a published time to the message digest to create a timestamp, and digitally signs the timestamp with a private key. The published time is from a trusted time source. The digital signature verifies the integrity of the message and timestamp and authenticates the timestamp. Digital time stamping services and encryption techniques for use with these services are well known. In any digital time stamping service, it is critical that there is a secure trusted time source to provide a published time for the timestamp so that each file or message is dated using a secure trusted method. For many reasons, connection to a trusted time source can be unreliable or not secure enough to ensure that every file or message can be stamped in an accurate manner if this service is external and relies on network access. However, providing a trusted local time source such as an atomic clock also has disadvantages. For example, an atomic clock is rather expensive and physically large, and an unencrypted atomic clock can be mimicked so that a forged time reference can be created. That is, connecting to a trusted time source over a network can be unreliable or not safe, and providing a trusted local time such as an atomic clock can be rather expensive and have problems due to the large size of the atomic clock.

For the foregoing reasons, there is a need for an improved trusted high stability time source.

### SUMMARY OF THE INVENTION

It is therefore an object of the present invention to provide a trusted high stability time source for use with a digital time stamping service and a trusted external time source that does away with the need to rely on access to the external time source for every single timestamp and yet is not as expensive and physically large as most atomic clocks.

In carrying out the above object, a trusted high stability time source for use with a digital time stamping service and a trusted external time source is provided. The time source comprises a private time source, a published time source, at least one power supply, and control logic. The private time source indicates a private time, and the published time source indicates a published time. The at least one power supply is arranged to power the private time source and the published time source. The control logic is programmed to perform a time stamping operation and is programmed to perform a published time source update.

The time stamping operation is performed by receiving a message, appending the published time to the message to create a timestamp, and digitally signing the timestamp with a private key. The published time source update is performed by sending a request to the trusted external time source for a published time update, receiving a reply from the trusted external time source including the published time update, and updating the published time with the published time update if an update condition is satisfied. The update condition is based in part on a time difference between the private time and the published time update. That is, the trusted external time source is trusted to update the published time, however, the trust is not absolute, and an update is only allowed if the update condition is satisfied. This technique provides many of the advantages of using a trusted external time source yet overcomes some of the reliability problems associated with trusting external time sources that are accessed over networks.

More specifically, the update condition may comprise a number of conditions that, as a whole, guarantee a satisfactory level of security. Exemplary conditions are described herein. That is, two time sources are used in combination with a secure update technique.

In a preferred embodiment, the trusted high stability time source further comprises a printed circuit board including a connector for connecting to a bus of a computer. The private time source, the published time source, the at least one power supply, and the control logic are mounted to the printed circuit board. Further, in a preferred embodiment, the trusted high stability time source further comprises a first crystal oscillator configured to stabilize the private time source, and a second crystal oscillator configured to stabilize the published time source. The control logic may be programmed to perform the published time source update periodically depending on the local time source stability, for example, the control logic may be programmed to perform the published time source update at least once per month.

In a preferred embodiment, the update condition is not satisfied when the time difference between the private time and the published time update is greater than 6 hours. In a preferred embodiment, the control logic updates the published time with the published time update in an update manner based on a time difference between the published time and the published time update. More preferably, the update manner is a normal update manner when the time difference between the published time and the published time update is not greater than 5 seconds. Otherwise, the update manner is a slow update manner. In a preferred embodiment, the update condition is further based on an elapsed time between sending the request and receiving the reply. More preferably, the update condition is not satisfied when the elapsed time between sending the request and receiving the reply is greater than 15 seconds.

In a preferred embodiment, the control logic is further programmed to compare the private time with the published time to determine a time difference. The control logic indicates that the trusted high stability time source has expired and must be replaced when the time difference exceeds a predetermined threshold. More preferably, the predetermined threshold is six hours.

In a preferred embodiment, a tamperproof enclosure encapsulates the private time source, the published time source, and the control logic.

The advantages associated with embodiments of the present invention are numerous. For example, a trusted high stability time source of the present invention does rely on a trusted external time source yet restricts updating the published time to when an update condition based in part on a time difference between the private time and the published time update is satisfied.

The above object and other objects, features, and advantages of the present invention are readily apparent from the following detailed description of the preferred embodiment when taken in connection with the accompanying drawings.

### BRIEF DESCRIPTION OF THE DRAWINGS

FIG. 1 is a trusted high stability time source of the present invention;

FIG. 2 is a block diagram illustrating a time stamping operation of the present invention;

FIG. 3 is a block diagram illustrating a published time source update of the present invention;

FIG. 4 is a flow chart illustrating a preferred published time source update of the present invention that uses an update condition consisting of multiple conditions; and

FIG. 5 is a graph depicting private time T1, published time T2, and trusted external time T3 versus absolute time in a preferred embodiment.

### DETAILED DESCRIPTION OF THE PREFERRED EMBODIMENTS

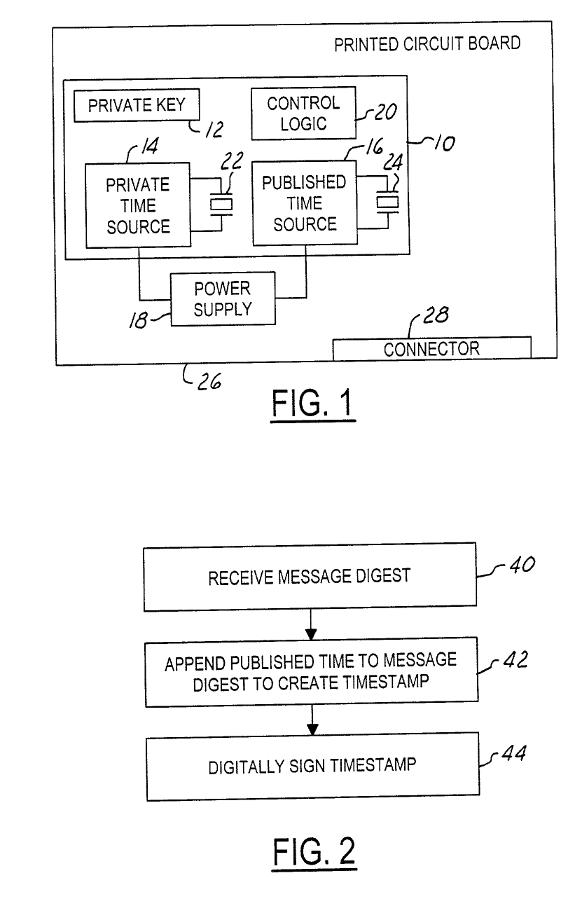

FIG. 1 illustrates a trusted high stability time source of the present invention, including preferred tamperproof enclosure 10. Tamperproof enclosure 10 encapsulates a private key 12, a private time source 14, and a published time source 16. Preferably, enclosure 10 encapsulates private key 12 as well as a public key and a key pair certificate. Private time source 14 indicates a private time. Published time source 16 indicates a published time. A power supply 18 is arranged to power private time source 14 and published time source 16. Control logic 20 is also encapsulated by tamperproof enclosure 10. Control logic 20 is programmed to perform a time stamping operation and to perform a published time source update.

In a preferred embodiment, tamperproof enclosure 10 and power supply 18 are mounted to a printed circuit board 26. Printed circuit board 26 includes a connector 28 for connecting to a bus of a computer such as, for example, a peripheral component interconnect (PCI) bus. Further, in a preferred embodiment, private time source 14 is stabilized by a first crystal oscillator 22 and published time source 16 is stabilized by a second crystal oscillator 24. That is, a preferred embodiment provides a trusted high stability time source with a small form factor that is inexpensive, supplies a published time, receives automatic updates, is accurate, and has the time sources encapsulated in a tamperproof enclosure. Preferably, the tamperproof enclosure complies with Federal Information Processing Standards publication 140-2, Level 4 (FIPS 140-2, Level 4).

More specifically, in a preferred embodiment, private time source 14 is accurately set up at the factory level, before tamperproof encapsulation, and cannot be updated. Trying to update private time source 14 by any means leads to time source destruction. Published time source 16 is set up synchronously at the factory level, before tamperproof encapsulation, and can be updated within some very restricted conditions. The trusted external time source, for example, an atomic clock reference, is provided by an independent or trusted organism. The trusted external time source is used to update published time source 16 when the update conditions are satisfied. More specifically, private time source 14 and published time source 16 are in a tamperproof enclosure meeting FIPS 140-2, Level 4, security requirements for cryptographic modules, with the cryptographic keys. Any attempt to tamper with the encapsulated time sources, private key, or control logic results in the complete loss of the private key and destruction of the trusted high stability time source.

In accordance with the present invention, private time source 14 and published time source 16 may use different, average accuracy, average stability quartz crystals. That is, the local time source can be constructed in a less expensive way than an atomic clock. The local time source need only be accurate enough to maintain sufficient accuracy between updates.

In FIG. 2, the performing of a time stamping operation is illustrated. At block 40, a message digest is received. At block 42, the published time from published time source 16 is appended to the message digest to create a timestamp. At block 44, the timestamp is digitally signed with private key 12. That is, a digital time stamping service is performed utilizing the published time indicated by published time source 16. As shown, a message digest is digitally stamped and signed, however, any suitable message may be digitally stamped and signed and a message digest is the preferred type of message. Embodiments of the present invention utilize a private time source and a public time source, together with restrictive update conditions, to provide a trusted high stability time source that is less expensive than providing a local atomic clock while also overcoming some of the reliability problems associated with external time sources.

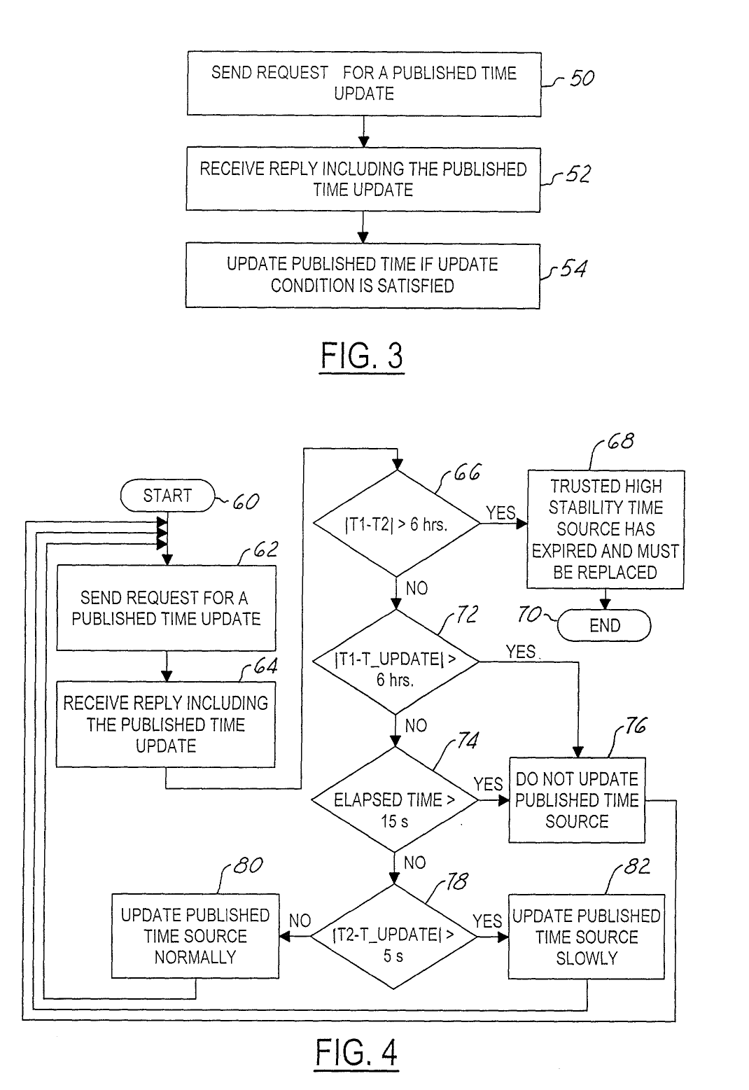

In FIG. 3, the performing of a published time source update is illustrated. At block 50, a request is sent to the trusted external time source for a published time update. At block 52, a reply is received from the trusted external time source including the published time update. At block 54, the published time is updated with the published time update if an update condition is satisfied. The update condition is based in part on a time difference between the private time and the published time update. More restrictive update conditions may also be used if desired. In addition, during a time stamping operation, other information in addition to the published time may be appended to the message digest if desired. For example, the trusted high stability time source could return a signed dated timestamp including the message digest, published time, and the last valid calibration from present time in days, an indicator of time source validity, signatures, and/or public keys or public key certificates. Of course, it is appreciated that these and other features are optional, and that there are a number of ways to provide embodiments of the present invention that utilize a private time source and a published time source to create a trusted high stability time source having restricted update conditions.

In FIG. 4, a preferred way to perform a published time source update is illustrated. More specifically, a request for a published time update is sent and a reply including the published time update is received (blocks 60, 62, 64). As shown in FIG. 4, decision block 66 compares private time T1 to published time T2. At block 68, the trusted high stability time source has expired and must be replaced if the time difference between private time T1 and published time T2 exceeds six hours. Flow ends at block 70. If the security condition at decision block 66 is satisfied in that the time difference between private time T1 and published time T2 does not exceed six hours, flow proceeds to the remaining decision blocks where the update condition is checked.

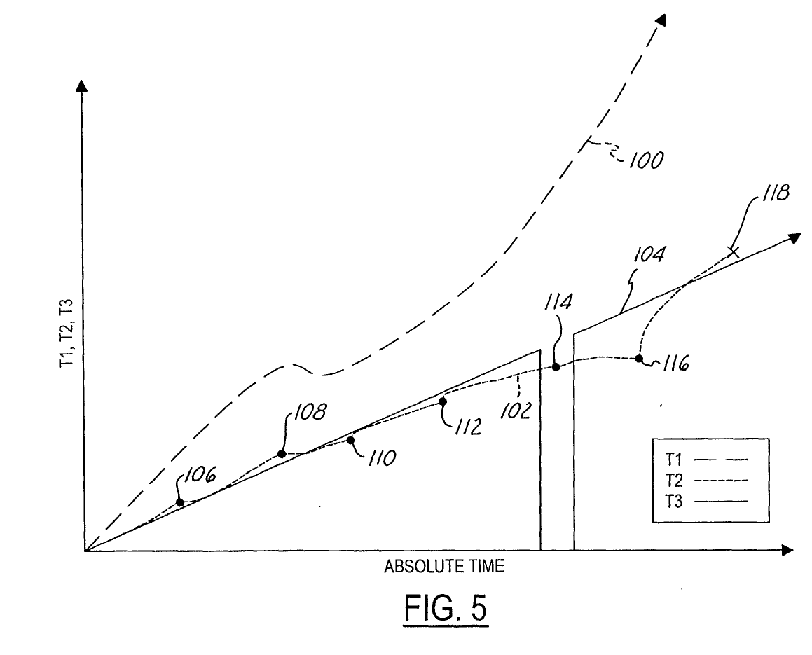

At decision block 72, private time T1 is compared to published time update T_UPDATE. The update condition is deemed not satisfied if the time difference exceeds six hours which causes flow to proceed to block 76. At block 76, the published time source is not updated with the published time source update. Specifically, block 76 determines that the update condition is not satisfied when T_UPDATE is considered unreliable caused perhaps by a temporary disorder at the trusted external time source T3. When the time difference between private time T1 and published time T_UPDATE does not exceed six hours, flow proceeds to decision block 74. Block 74 determines that the update condition is not satisfied when the elapsed time between sending the request and receiving the reply is greater than 15 seconds. If all three conditions are met, the update condition in the preferred embodiment is deemed satisfied and flow proceeds to decision block 78. Block 78 compares published time T2 and published time update T_UPDATE and determines if a time difference between published time T2 and published time update T_UPDATE exceeds 5 seconds. If the time difference does not exceed 5 seconds, flow proceeds to block 80 and the published time source is updated normally. In the event that the time difference does exceed 5 seconds, flow proceeds to block 82 and the published time source is updated more slowly. That is, in a preferred embodiment, the difference between the published time source and the published time source update should not exceed 5 seconds per period (the updates are performed periodically such as once per day). This condition is preferably established to prevent abrupt changes in the published time source. In addition, time source monotonicity should be assured. For example, if the published time source gets less than 5 seconds ahead of absolute time, the published time source can be temporarily stopped until absolute time catches up. If the published time source falls behind absolute time by less than 5 seconds, the published time source can be bumped to the present absolute time. In the event that the time difference exceeds five seconds between the published time source and the published time source update, the published time source should be updated more slowly as more clearly illustrated in FIG. 5.

FIG. 5 illustrates private time T1, published time T2, and trusted external time T3 versus absolute time in a preferred embodiment. Private time T1 is indicated in long dashed line at 100. Published time T2 is indicated in short dashed line 102. Trusted external time T3 is indicated in solid line at 104. Private time T1 is never updated and drifts over time. Trusted external time T3 normally tracks absolute time, but occasionally may be unreliable for short periods of time. Published time T2 has some drift, and is periodically updated with a published time update from the trusted external time source so as to keep published time T2 reliable. More specifically, beginning at the origin, published time T2 begins to drift and is then updated at point 106. Published time T2 again begins to drift and is updated at point 108, and is further updated at points 110 and 112. At points 106 and 108, published time T2 exceeds the received published time update by less than five seconds and is updated normally by holding the published time at the same time until absolute time catches up with the published time source. At points 110 and 112, the published time falls behind the absolute time by less than five seconds and is updated normally by immediately advancing the published time to catch up with absolute time. At point 114, the received published time update differs from the private time by more than six hours due to the temporary unreliability of the external time source T3, and accordingly, the published time source is not updated at point 114 (FIG. 4, blocks 72, 76). In addition, a delay of more than 15 seconds between the request and the reply for a published time update would also cause the published time source not to be updated (FIG. 4, blocks 74, 76). At point 116, the published time differs from the published time update by more than five seconds and the published time source is updated slowly (block 82). In the example for updating the published time source slowly, instead of immediately adjusting (or holding) the published time, the published time is gradually adjusted until the published time meets with absolute time. Finally, at point 118, private time T1 and published time T2, due to continuous drift of private time source T1, become more than six hours apart and the security condition check indicates that the trusted high stability time source has expired and must be replaced (FIG. 4, blocks 66, 68).

It is appreciated that the cryptographic techniques utilized by embodiments of the present invention may take any suitable form as apparent to one of ordinary skill in the art. For example, various techniques for determining a message digest such as hash functions are known in the art of digital time stamping services. In addition, various techniques for providing digital signatures are also known. Still further, communications between the trusted high stability time source and the trusted external time source are secured in any suitable fashion. In one example, both the published time update request and the reply from the trusted external time source are encrypted. In another example, the published time update request is not encrypted, and the reply from the trusted external time source includes the time update along with a hash of the unencrypted request. The reply is digitally signed. The advantage of using an unencrypted request and a signed but unencrypted reply is that processing time is reduced so that the update protocol can go faster.

An example solution using encryption is as follows. The published time update request is encrypted with the public key of the trusted external time source. The reply from the trusted external time source is encrypted with the private key of the trusted external time source. Accordingly, embodiments of the present invention are not limited to any specific techniques for cryptography. Embodiments of the present invention advantageously provide a trusted high stability time source utilizing a private time source and a published time source, together with security conditions including a restrictive update condition that must be satisfied to allow updating of the published time source. The trusted high stability time source need not rely on access to the external time source for every single timestamp yet is not as expensive and physically large as most atomic clocks.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A trusted high stability time source for use with a digital time stamping service and a trusted external time source, the time source comprising:
a private time source indicating a private time;
a published time source indicating a published time;
at least one power supply arranged to power the private time source and the published time source; and
control logic programmed to perform a time stamping operation by receiving a message, appending the published time to the message to create a timestamp, and digitally signing the timestamp with a private key, the control logic being further programmed to perform a published time source update by sending a request to the trusted external time source for a published time update, receiving a reply from the trusted external time source including the published time update, and updating the published time with the published time update if an update condition is satisfied, wherein the update condition is based in part on a time difference between the private time and the published time update.

2. The trusted high stability time source of claim 1 further comprising:
a printed circuit board including a connector for connecting to a bus of a computer, wherein the private time source, the published time source, the at least one power supply, and the control logic are mounted to the printed circuit board.

3. The trusted high stability time source of claim 1 further comprising:
a first crystal oscillator configured to stabilize the private time source; and
a second crystal oscillator configured to stabilize the published time source.

4. The trusted high stability time source of claim 1 wherein the control logic is programmed to perform the published time source update at least once per month.

5. The trusted high stability time source of claim 1 wherein the update condition is not satisfied when the time difference between the private time and the published time update is greater than 6 hours.

6. The trusted high stability time source of claim 1 wherein the control logic updates the published time with the published time update in an update manner that is based on a time difference between the published time and the published time update.

7. The trusted high stability time source of claim 6 wherein the update manner is a normal update manner when the time difference between the published time and the published time update is not greater than 5 seconds, otherwise, the update manner is a slow update manner.

8. The trusted high stability time source of claim 7 wherein the control logic is programmed to perform the published time source update once per day.

9. The trusted high stability time source of claim 1 wherein the update condition is further based on an elapsed time between sending the request and receiving the reply.

10. The trusted high stability time source of claim 9 wherein the update condition is not satisfied when the elapsed time between sending the request and receiving the reply is greater than 15 seconds.

11. The trusted high stability time source of claim 1 wherein the control logic is further programmed to compare the private time with the published time to determine a time difference, and to indicate that the trusted high stability time source has expired when the time difference exceeds a predetermined threshold.

12. The trusted high stability time source of claim 11 wherein the predetermined threshold is 6 hours.

13. The trusted high stability time source of claim 1 further comprising:
a tamperproof enclosure encapsulating the private time source, the published time source, and the control logic.
